(19) United States
(12) Patent Application Publication
(10) Pub. No.: US 2010/0123302 A1
(43) Pub. Date: May 20, 2010

(54) INDUCTIVE VEHICLE SEAT POSITION SENSOR ASSEMBLY

(75) Inventors: Christopher Richard Bujak, New Baltimore, MI (US); Manoharprasad K. Rao, Novi, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/273,090

(22) Filed: Nov. 18, 2008

(51) Int. Cl. B60R 21/015

(52) U.S. Cl. 280/735; 701/45; 340/686.1

(57) ABSTRACT

An inductive vehicle seat position sensor assembly determines a linear vehicle seat position and has a circuit board member. First and second transmitter coils are proximate to a periphery of the circuit board member and radiate an out of phase magnetic field in response to an alternating current input. First and second receiver coils are offset relative to one another. The first and second transmitter coils and the first and second receiver coils span along the circuit board member. A loop coil member is provided for relative motion to the circuit board member. The first and second receiver coils generate a voltage with phase information corresponding to a position of the loop coil member relative to the circuit board member. A signal conversion unit produces a seat position output corresponding to the vehicle seat position based on the voltage with phase information of the first and second receiver coils.

### BACKGROUND

1. Technical Field

Multiple embodiments relate to position sensor assemblies for vehicle seats.

2. Background Art

Currently, vehicle seat position sensors are utilized to determine seat position along a track of the vehicle seat. The vehicle seat position sensors are employed as an input to a restraint control module as a part of a safety system deployment strategy for front seat occupants. Typically, vehicle seat position sensors have a limited capability to only detect two distinct fore/aft zones (near and far) as needed by current safety system strategies. These vehicle seat position sensors function as switches and do not provide higher resolution seat linear position information. Often the vehicle seat position sensors are based upon the Hall effect/magnetic sensing. Switches in the vehicle seat position sensors indicate that an occupant is sitting too close to a safety system upon deployment, such as an airbag and help optimize airbag deployment for this condition.

### SUMMARY

In one embodiment, an inductive vehicle seat position sensor assembly to determine a linear vehicle seat position is provided with a circuit board member. First and second transmitter coils are each arranged proximate to a periphery of the circuit board member and radiate an out of phase magnetic field in response to an alternating current input. The first and second transmitter coils each span a length along the circuit board member. First and second receiver coils have a waveform and are offset relative to one another within the first and second transmitter coils. The first and second receiver coils each span the length along the circuit board member. A loop coil member is provided for relative motion to the circuit board member along the length of the circuit board member to interact with the first and second transmitter coils and the first and second receiver coils via inductive coupling. In response to the loop coil member positioned over the transmitter and receiver coils, each of the first and second receiver coils generate a voltage with phase information corresponding to a position of the loop coil member relative to the circuit board member. A signal conversion unit produces a seat position output corresponding to the vehicle seat position based on the unique voltage/phase of each of the first and second receiver coils.

In another embodiment, an inductive vehicle seat position sensor system has an inductive sensor assembly to determine a vehicle seat position. A circuit board member is provided. First and second transmitter coils are each arranged proximate to a periphery of the circuit board member and radiate an out of phase magnetic field in response to an alternating current input. The first and second transmitter coils each span a length along the circuit board member. First and second receiver coils have a waveform and are offset relative to one another within the first and second transmitter coils. The first and second receiver coils each span the length along the circuit board member. A loop coil member is provided for relative motion to the circuit board member along the length of the circuit board member for interacting with the first and second transmitter coils and the first and second receiver coils via inductive coupling. In response to the loop coil member positioned over the transmitter and receiver coils, each of the first and second receiver coils generates a voltage with phase information. A signal conversion unit produces a seat position output corresponding to the vehicle seat position based on the unique voltage/phase of each of the first and second receiver coils. A restraint control module communicates with the inductive sensor assembly to receive the seat position output and communicates with at least one auxiliary passenger safety device to provide an input.

In another embodiment, a vehicle seat frame assembly is provided. A vehicle seat frame has a pair of generally parallel lateral frame members that are slidably engageable with a pair of seat tracks adapted to be mounted to a vehicle floor. An inductive sensor assembly determines a position of the lateral frame members relative to the seat tracks. A restraint control module communicates with the inductive sensor assembly and communicates with at least one auxiliary passenger safety device to provide an input.

### BRIEF DESCRIPTION OF THE DRAWINGS

FIG. 1 is a schematic representation of a vehicle seat frame equipped with an inductive vehicle seat position sensor assembly;

FIG. 2 is a schematic overview of a vehicle safety system with an inductive vehicle seat position sensor assembly according to the present invention;

FIG. 3 is a top view of an embodiment of an inductive vehicle seat position sensor assembly;

FIG. 4 is a side view of the inductive vehicle seat position sensor assembly of FIG. 3 with an attached signal conversion unit; and

FIG. 5 is a graph comparing seat track position to sensor output voltage.

### DETAILED DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

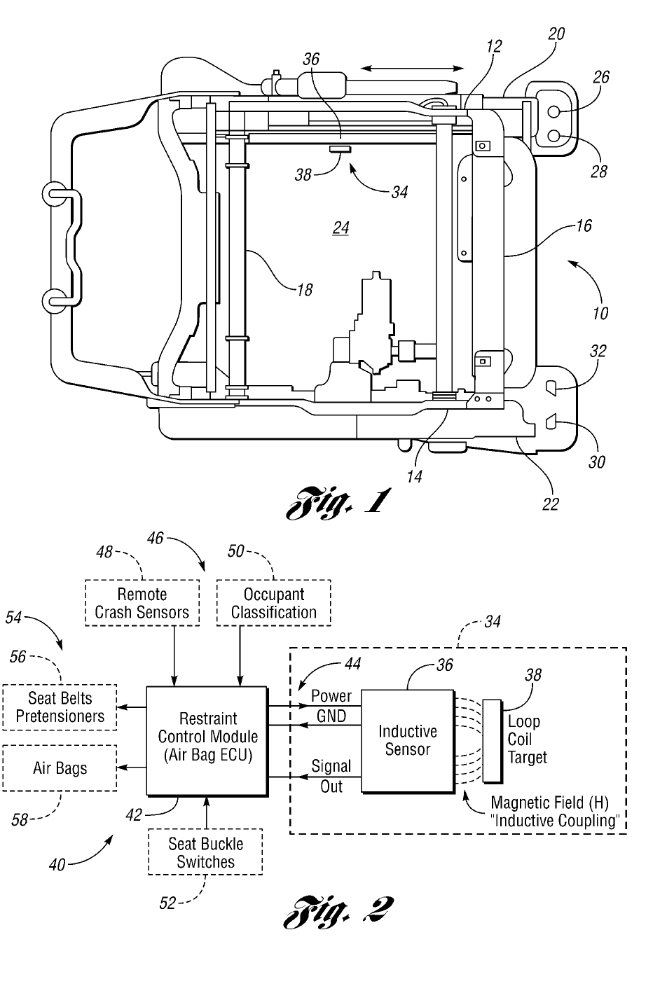

With reference to FIG. 1, a detailed top view of a vehicle seat is illustrated and generally referenced by numeral 10. For illustrative purposes, trim and cushioning have been removed. While only a passenger seat 10 is depicted, a driver seat is also contemplated within the scope of the embodiments disclosed.

As illustrated, the vehicle seat 10 has lateral frame members 12, 14, respectively that are spaced apart by cross members 16, 18, respectively. The vehicle seat 10 is arranged to move linearly along seat tracks 20, 22, which are adapted to be mounted in a vehicle floor 24 by attachments through apertures 26, 28, 30, and 32, respectively. It is apparent that while one method of mounting the vehicle seat 10 to the vehicle floor 24 is illustrated, any manner of attaching the seat tracks 20, 22 to the vehicle floor 24 is contemplated within the description of the multiple embodiments disclosed. The seat tracks 20, 22 are generally substantially parallel to one another and serve to permit the vehicle seat 10 to travel to different positions linearly within an interior of a vehicle compartment.

Along at least one of the seat tracks 20, 22, or at least in close proximity thereto, and generally parallel to at least one of the seat tracks 20, 22, is an inductive vehicle seat position sensor assembly 34. The inductive vehicle seat position sensor assembly 34 is provided on or relative to the vehicle seat 10 to determine the position of the vehicle seat 10 relative to the tracks 20 as the vehicle seat 10 travels linearly in a fore/aft direction indicated by the arrow 39 provided proximate to the vehicle seat 10.

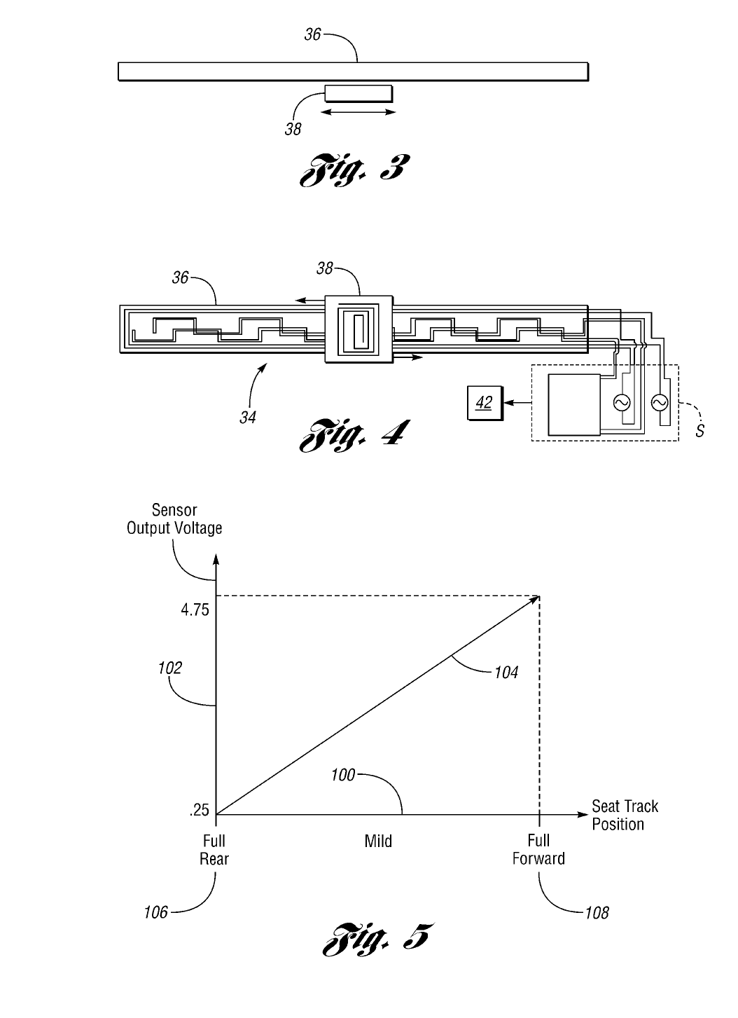

The inductive vehicle seat position sensor assembly 34 has an inductive sensor 36 and a loop coil member 38. The inductive sensor 36 and the loop coil member 38 of the inductive vehicle seat position sensor assembly 34 are illustrated in FIGS. 3-4 and are discussed in detail below.

As depicted in FIG. 1, the inductive sensor 36 may mounted directly to the track 20 or adjacent the track 20 so that the circuit board member 60 of the sensor 36 does not move in the fore/aft direction. The loop coil member 38 may be mounted on at least one of the lateral frame members 12, 14 in close proximity to the inductive sensor 36. Since the inductive sensor 36 is affixed in one position relative to the lateral frame members 12, 14, movement of the vehicle seat 10 in the fore/aft direction causes the loop coil member 38 to move linearly in the fore/aft direction relative to the inductive sensor 36 and thereby sense changes in voltage/phase caused through induction.

In another embodiment, the inductive sensor 36 is mounted on at least one of the lateral frame members 12, 14. The loop coil member 38 is mounted directly to the track 20 or adjacent the track 20 so that the loop coil member 38 does not move in the fore/aft direction. Movement of the vehicle seat 10 in the fore/aft direction as indicated by the arrow 39 proximate the vehicle seat 10 causes the inductive sensor 36 to also move linearly in the fore/aft direction relative to the loop coil member 38 so that the inductive sensor 36 thereby senses changes in voltage/phase caused through induction.

Referring now to FIG. 2, a vehicle safety system with an inductive vehicle seat position sensor system is illustrated and generally referenced by numeral 40. The vehicle safety system 40 may include inductive vehicle seat position sensor assembly 34. The inductive vehicle seat position sensor assembly 34 is comprised of the inductive sensor 36 and the loop coil member 38 as described in reference to FIG. 1. The inductive vehicle seat position sensor assembly 34 is electrically connected to a remote electronic control unit 42. In at least one embodiment, the remote electronic control unit 42 is a restraint control module (RCM). The RCM 42 may supply the inductive vehicle seat position sensor assembly 34 with the power as indicated at 44, and the inductive vehicle seat position sensor assembly 34 sends a signal to the RCM 42 indicative of the linear position in the fore/aft direction of the vehicle seat 10 within the vehicle compartment. The RCM 42 receives additional data signals from safety input devices 46, shown here as remote crash sensors 48, occupant classification sensors 50 and seat belt buckle switches 52. The RCM 42 may have a memory that may be volatile and nonvolatile, EPROM/EEPROM, flash or any other memory, with tables resident therein with values for controlling auxiliary safety devices 54, shown as seat belt pretensioners 56 and airbags 58.

It can be extremely important that all occupant information be made available to the RCM 42 so that all the safety devices 46, 54 work together to enhance occupancy safety. For example, it is significant to know the linear position in the fore/aft direction of the vehicle seat 10 within the vehicle so that airbags are inflated at a proper rate and intensity to provide maximum protection to the occupant in the vehicle seat 10. The input of additional data from the remote crash sensors 48, occupant classification sensors 50, and seat belt buckle switches 52 all enhance operation of the seat belt pretensioners 56 and/or airbags 58 during vehicle crash events. Values may be stored in the RCM 42 tables indicative of various intensities and rates of activation for these devices based upon input to the RCM 42, including linear seat position within the vehicle during a crash event.

Referring now to FIGS. 3 and 4, a detailed view of the inductive vehicle seat position sensor assembly 34 is illustrated. The sensor assembly 34 has an inductive sensor 36 and a loop coil member 38. The inductive sensor 36 has a circuit board member 60 that is mounted within the vehicle. In at least one embodiment, one of the circuit board member 60 and the loop coil member 38 move relative to one another. In one embodiment, the circuit board member 60 is fixedly mounted within the vehicle and the loop coil member 38 is mounted to a moveable lateral frame member of the vehicle seat so that the loop coil member 38 moves relative to the circuit board member 60. In another embodiment, the loop coil member 38 is fixedly mounted within the vehicle and the circuit board member 60 is mounted to a moveable lateral frame member of the vehicle seat so that the circuit board member 60 moves relative to the loop coil member 38.

The circuit board member 60 is a substrate of fiberglass or other flat insulating sheet material and is an electrically insulating material that has a lightweight. Of course, any suitable circuit board member 60 is contemplated within the scope of the disclosed embodiments.

As illustrated, a first transmitter coil 62 and a second transmitter coil 64 are mounted on the circuit board member 60. The first transmitter coil 62 and the second transmitter coil 64 are mounted proximate to the periphery of the circuit board member 60. The first transmitter coil 62 and the second transmitter coil 64 are excitation coils that may be wires of copper or other conductor imprinted to or adhered to the circuit board member 60. Although first and second transmitter coils 62, 64 are illustrated, any amount of transmitter coils 62, 64 are contemplated within the scope of the disclosed embodiments. The first transmitter coil 62 and the second transmitter coil 64 are connected to an integrated circuit 66. The integrated circuit 66 serves as an excitation and processing circuit. The integrated circuit 66 also has a signal conversion unit 80. In at least one embodiment, the integrated circuit 66 is a power source for the sensor assembly 34.

The first and second transmitter coils 62, 64 each receive an input from the integrated circuit 66. The input may be an alternating current. The first and second transmitter coils 62, 64 each produce respective multi-phase magnetic fields that are inductively coupled to a first receiver coil 68 and a second receiver coil 70 by the loop coil member 38.

The first receiver coil 68 and the second receiver coil 70 each have a waveform with a period that may be equal. As illustrated, the first receiver coil 68 and the second receiver coil 70 waveforms are out of phase when compared to one another so that each location of the loop coil member 38 along the circuit board member 60 induces voltages with unique phase information in the first receiver coil 68 and the second receiver coil 70. The measured output voltage/phase of the first receiver coil 68 and the second receiver coil 70 is a function of the position of the loop coil member 38 relative to the circuit board member 60 and thus of the linear position of the movable seat frame with respect to the fixed seat track. The receiver coil voltage and phase measurements are converted to a sensor signal output using a lookup table and interpolating a relative value. The sensor signal output, as seen in FIG. 2, is connected to the RCM 42.

Referring to FIG. 4, the inductive sensor 34 may interface to the RCM 42 via the integrated circuit 66. In one embodiment, the integrated circuit 66 is an integrated circuit with an analog output signal. In another embodiment, the integrated circuit 66 is an integrated circuit with a digital output signal. Of course, any suitable integrated circuit 66 is contemplated within the scope of the multiple embodiments disclosed.

The inductive vehicle seat position sensor assembly 34 employs relatively inexpensive printed circuit board 60 with coils implemented using circuit traces, which provides a low cost sensor assembly 34. Additionally, the inductive vehicle seat position sensor assembly 34 is relatively insensitive to changes in distance between the inductive sensor 36 and the loop coil member 38, which provides the sensor assembly 34 greater flexibility when mounted within the vehicle than compared to prior art sensor assemblies in vehicles. Furthermore, the inductive vehicle seat position sensor assembly 34 has diagnostic detection capabilities so that the assembly 34 can be tested before the vehicle is fully assembled. The inductive vehicle seat position sensor assembly 34 does not require sensitive, heavy, expensive magnets, which may be influenced by temperature, contaminants, and/or electromagnetic disturbances. Fewer parts are employed because of the use of a single sensor 36 and a single loop coil member 38. In addition, the inductive vehicle seat position sensor assembly 34 has a continuous (non-discrete) sensing range, which allows for greater sensitivity when compared to prior art sensor assemblies. The inductive vehicle seat position sensor assembly 34 also has a simple construct and does not require the additional weight of other electronics to determine position.

In FIG. 5, a representation of seat track position in relation to voltage of the signal assembly is illustrated. The x-axis 100 is linear seat position, ranging from full rear to full forward position of the seat, and the y-axis 102 is sensor output voltage. The relationship between linear seat position and voltage is depicted at 104, and can be understood to be linear. When the seat is in the rearward portion 106, the voltage is relatively low, and as the seat travels linearly toward the full forward position 108, the voltage is relatively high. In this depiction, the voltage ranges from 0.25 volts to 4.75 volts, but any range of voltages may be seen, the only limitation being that the relationship between fore and aft seat position and voltage is linear.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. An inductive vehicle seat position sensor assembly to determine a linear vehicle seat position, the position sensor comprising:
a circuit board member;
first and second transmitter coils each arranged proximate to a periphery of the circuit board member and each radiating an out of phase magnetic field in response to an alternating current input, the first and second transmitter coils each spanning a length along the circuit board member;
first and second receiver coils each having a waveform and being offset relative to one another within the first and second transmitter coils, the first and second receiver coils each spanning the length along the circuit board member;
a loop coil member provided for relative motion to the circuit board member along the length of the circuit board member to interact with the first and second transmitter coils and the first and second receiver coils via inductive coupling, such that in response to the loop coil positioned over the transmitter and receiver coils, each of the first and second receiver coils generate a voltage with phase information corresponding to a position of the loop coil member relative to the circuit board member; and
a signal conversion unit to produce a seat position output corresponding to the vehicle seat position based on the voltage with phase information of each of the first and second receiver coils.

2. The inductive vehicle seat position sensor assembly of claim 1 wherein the circuit board member further comprises a printed circuit board member such that the first and second transmitter coils and the first and second receiver coils are imprinted thereon.

3. The inductive vehicle seat position sensor assembly of claim 1 wherein the circuit board is stationary and the loop coil member is moveable.

4. The inductive vehicle seat position sensor assembly of claim 1 wherein the circuit board is moveable and the loop coil member is stationary.

5. A vehicle safety system comprising:
an inductive sensor assembly to determine a vehicle seat position having:
a circuit board member,
first and second transmitter coils each arranged proximate to a periphery of the circuit board member and each radiating an out of phase magnetic field in response to an alternating current input, the first and second transmitter coils each spanning a length along the circuit board member,
first and second receiver coils each having a waveform and being offset relative to one another within the first and second transmitter coils, the first and second receiver coils each spanning the length along the circuit board member,
a loop coil member provided for relative motion to the circuit board member along the length of the circuit board member for interacting with the first and second transmitter coils and the first and second receiver coils via inductive coupling such that in response to the loop coil member positioned over the transmitter and receiver coils, each of the first and second receiver coils generate a voltage with phase information, and
a signal conversion unit produces a seat position output corresponding to the vehicle seat position based on the voltage with phase information of each of the first and second receiver coils; and
a restraint control module in communication with the inductive sensor assembly to receive the seat position output and generating an output for at least one auxiliary passenger safety device.

6. The vehicle safety system of claim 5 wherein the at least one auxiliary safety device further comprises a seatbelt pretensioner.

7. The vehicle safety system of claim 5 wherein the at least one auxiliary safety device further comprises an airbag.

8. The vehicle safety system of claim 5 wherein the at least one auxiliary safety device further comprises a seatbelt pretensioner and an airbag.

9. The vehicle safety system of claim 5 wherein the restraint control module is in communication with an input of a remote crash sensor.

10. The vehicle safety system of claim 5 wherein the restraint control module is in communication with an input of a seatbelt buckle switch.

11. The vehicle safety system of claim 5 wherein the restraint control module is in communication with an input of an occupant classification sensor.

12. The vehicle safety system of claim 5 wherein the restraint control module is in communication with an input of a remote crash sensor, a seatbelt buckle switch, and an occupant classification sensor.

13. The inductive vehicle seat position sensor assembly of claim 5 wherein a voltage/phase of each of the first and second receiver coils has a low voltage value when the vehicle seat position is in a rearward position and a high voltage when the vehicle seat position is in a forward position.

14. The inductive vehicle seat position sensor assembly of claim 5 wherein the vehicle seat position has a linear relationship between voltage and seat position.

15. A vehicle seat frame assembly comprising:
a vehicle seat frame with a pair of generally parallel lateral frame members slidably engageable with a pair of seat tracks adapted to be mounted to a vehicle floor;
an inductive sensor assembly to determine a position of the lateral frame members relative to the seat tracks; and
a restraint control module in communication with the inductive sensor assembly and generating output for at least one auxiliary passenger safety device.

16. The vehicle frame assembly of claim 15 wherein the inductive sensor assembly further comprises:
a circuit board member,
first and second transmitter coils each arranged proximate to a periphery of the circuit board member and each radiating an out of phase magnetic field in response to an alternating current input, the first and second transmitter coils each spanning a length along the circuit board member,
first and second receiver coils each having a waveform and being offset relative to one another within the first and second transmitter coils, the first and second receiver coils each spanning the length along the circuit board member,
a loop coil member provided for relative motion to the circuit board member along the length of the circuit board member for interacting with the first and second transmitter coils and the first and second receiver coils such that in response to the loop coil positioned over the transmitter and receiver coils, each of the first and second receiver coils generate a voltage with phase information, and
a signal conversion unit produces a seat position output corresponding to the to the position of the lateral frame members relative to the seat tracks based on the voltage with phase information of each of the first and second receiver coils.

17. The vehicle seat frame assembly of claim 15 wherein the restraint control module generating output for at least one auxiliary safety device further comprises generating output for a seatbelt pretensioner and an airbag.

18. The vehicle seat frame assembly of claim 15 wherein the restraint control module is in communication with an input of a seatbelt buckle switch.

19. The vehicle seat frame assembly of claim 15 wherein the restraint control module is in communication with an input of a remote crash sensor, a seatbelt buckle switch, and an occupant classification sensor.

20. The inductive vehicle seat position sensor assembly of claim 16 wherein a total voltage of each of the first and second receiver coils has a low voltage value when the lateral frame members relative to the seat tracks is in a rearward position and a high voltage when the lateral frame members relative to the seat tracks is in a forward position.
